(19) United States
(12) Patent Application Publication
(10) Pub. No.: US 2008/0029360 A1
(43) Pub. Date: Feb. 7, 2008

(54) Automatic Clutch Mechanism, Automatic Clutch Mechanism for Straddle-Type Vehicle, and Straddle-Type Vehicle

(75) Inventors: Kenji YAMASHITA, Shizuoka (JP); Tatsuya MASUDA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 11/833,116

(22) Filed: Aug. 2, 2007

(30) Foreign Application Priority Data
Aug. 3, 2006 (JP) 2006-212621

(51) Int. Cl. B60W 10/02; B60W 10/10; B60K 23/02; F16D 13/56

(52) U.S. Cl. 192/3.61; 192/3.63; 192/70.27; 192/96

(57) ABSTRACT

An automatic clutch mechanism that allows the feel of gear shifting to be readily transmitted to a rider through a pedal. The automatic clutch mechanism shifts gears while disengaging a clutch in conjunction with one pedal operation. A transmission effects a gear shift in conjunction with a pedal operation. The clutch includes an elastic member, and an engaging portion for bringing the transmission and an engine into engagement with each other by the elastic reaction force of the elastic member. The elastic member has a gradient-decreasing range in which the gradient of a change in elastic load with respect to deformation of the elastic member decreases as the deformation increases. The gradient-decreasing range is included in the use range of the elastic member determined by operation of the clutch.

### RELATED APPLICATIONS

This application claims the benefit of priority under 35 USC 119 of Japanese patent application nos. 2006-212621, filed on Aug. 3, 2006, which application is hereby incorporated by reference in its entirety.

### BACKGROUND OF THE INVENTION

1. Field of the Invention

The present invention relates to an automatic clutch mechanism, and more specifically to an automatic clutch mechanism suitable for use in straddle-type vehicles such as a motorcycle or ATV.

2. Description of Related Art

With a view to achieving improved operability for the rider, a straddle-type vehicle equipped with an automatic clutch mechanism has been proposed for effecting clutch disengagement/engagement and gear shift simultaneously solely by operating a shift pedal with a foot (for example, see JP-A-2005-42910). In JP-A-2005-42910, a coil spring (elastic member) urges a pressure plate to bring a friction plate and a clutch plate into press contact with each other. The coil spring is placed under compression so as to be capable of urging the pressure plate with a required elastic reaction force at all times. A release mechanism actuated by operation of a pedal displaces the pressure plate against the elastic reaction force of the coil spring to thereby disengage the clutch. A mechanism for shifting gears is actuated when the clutch is disengaged, thereby shifting gears.

In the automatic clutch mechanism as described above, it is desired to make the operation reaction force encountered during pedal operation small. Further, at the time of gear shifting, the change in the reaction force exerted on the pedal is small in comparison with the reaction force exerted on the pedal. Therefore, the automatic clutch mechanism has a problem in that the feel of gear shifting is not effectively transmitted to the rider through the pedal.

### SUMMARY OF THE INVENTION

According to an embodiment of the present invention, an automatic clutch mechanism is provided that shifts gears while disengaging a clutch in conjunction with one pedal operation. A transmission shifts gears in conjunction with pedal operation. A clutch includes an elastic member and an engaging portion for bringing the transmission and an engine into engagement with each other by an elastic reaction force of the elastic member. The elastic member has a gradient-decreasing range in which a gradient of a change in elastic load with respect to deformation of the elastic member decreases as the deformation increases. The gradient-decreasing range is included in a use range of the elastic member determined by operation of the clutch.

In one implementation, the elastic member is configured so that the entirety of the use range is the gradient-decreasing range.

According to another embodiment of the invention, an automatic clutch mechanism shifts gears while disengaging a clutch in conjunction with one pedal operation. A transmission shifts gears in conjunction with pedal operation. A clutch includes an elastic member and an engaging portion for bringing the transmission and an engine into engagement with each other by an elastic reaction force of the elastic member. The elastic member has an elastic-load-decreasing range in which an elastic load with respect to deformation of the elastic member decreases as the deformation increases. The elastic-load-decreasing range is included in a use range of the elastic member determined by operation of the clutch.

In one implementation, the elastic member is configured so that the entirety of the use range is the elastic-load-decreasing range.

The automatic clutch mechanism may be configured so that the clutch includes a release mechanism for operation in conjunction with pedal operation. The elastic member engages with the engaging portion and the release mechanism. Due to operation of the release mechanism, a part of the elastic member engaging with the engaging portion is displaced relative to a part of the elastic member engaging with the release mechanism, and the elastic member exerts the elastic load.

In one implementation, the clutch is a multiplate clutch in which a friction plate and a clutch plate are overlaid together in a staggered fashion and a pressure plate is overlaid on one side thereof. The elastic member is a generally disc-shaped leaf spring. The automatic clutch mechanism further includes a mounting member that causes a radially intermediate position of an outer surface of the leaf spring in a natural state to abut against the pressure plate of the clutch, and engages with a radially outer part of the leaf spring with respect to the intermediate position of the leaf spring. The mounting member is configured to mount the leaf spring to the clutch by moving the radially outer part toward the pressure plate, and a release mechanism that engages with a radially inner part of the leaf spring with respect to the intermediate position of the leaf spring, and operates in conjunction with the pedal operation to move the radially inner part to a side opposite to the pressure plate.

The leaf spring may be configured so that a distance from the radially outer part engaging with the mounting member to the radially inner part engaging with the release mechanism is larger than a distance from the radially outer part engaging with the mounting member to the intermediate position abutting against the pressure plate. Further, the leaf spring may be, for example, a generally conical spring.

The release mechanism may include a pedal shaft rotatable in conjunction with a pedal; a conversion mechanism including an output member that outputs linear motion on the basis of rotation of the pedal shaft; a pushing member that abuts against the radially inner part of the conical spring, and moves linearly in conjunction with linear motion of the output member to push the conical spring away from the pressure plate; and a lever member having a fulcrum swingably supported on a fixing member, a force point at which linear motion is inputted from the output member, and an action point at which linear motion is outputted to the pushing member.

The lever member may be configured so that a distance from the fulcrum to the action point is larger than a distance from the fulcrum to the force point.

Another embodiment of the invention provides an automatic clutch mechanism for a straddle-type vehicle for shifting gears while disengaging a clutch in conjunction with one pedal operation. A transmission shifts gears in conjunction with pedal operation. A clutch includes an elastic member and an engaging portion for bringing the transmission and an engine into engagement with each other by an elastic reaction force of the elastic member. A mounting member mounts the elastic member in position by causing the elastic member to elastically deform while being abutted against the engaging portion of the clutch. A release mechanism releases the clutch by deforming the elastic member while engaging with the elastic member. The elastic member is configured so that a distance from a part of the elastic member abutted against the mounting member to a part of the elastic member engaging with the release mechanism is larger than the part of the elastic member abutted against the mounting member to a part of the elastic member abutted against the engaging portion of the clutch.

The elastic member may be a leaf spring, and the leaf spring may be a generally conical spring.

In one implementation, the automatic clutch mechanism is configured so that the elastic member is a generally conical spring. The release mechanism includes a pedal shaft rotatable in conjunction with a pedal; a conversion mechanism including an output member that outputs linear motion on the basis of rotation of the pedal shaft; a pushing member that abuts against the radially inner part of the leaf spring, and moves linearly in conjunction with linear motion of the output member to push the leaf spring away from a pressure plate; and a lever member having a fulcrum swingably supported on a fixing member, a force point at which linear motion is inputted from the output member, and an action point at which linear motion is outputted to the pushing member.

The lever member may be configured so that a distance from the fulcrum to the action point is larger than a distance from the fulcrum to the force point.

A straddle-type vehicle according to the present invention includes any of the automatic clutch mechanisms mentioned above.

With the automatic clutch mechanism of the invention, the reaction force exerted on the pedal becomes generally small in comparison with the related art, and thus the burden on the rider during pedal operation is reduced, thereby making it easier for the rider to operate the pedal. When the clutch is disengaged by operating the pedal and a gear shift is performed, the reaction force exerted on the pedal becomes generally small in comparison with the related art. Therefore, at the time of gear shifting, the change in the reaction force exerted on the pedal is readily transmitted to the rider through the pedal.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a block diagram of an automatic clutch mechanism according to an embodiment of the present invention.

FIG. 2 is a graph showing the relationship between the pedal operating angle and the reaction force exerted on a pedal in the automatic clutch mechanism according to an embodiment of the present invention.

FIG. 3 is a graph showing the relationship between the deformation and elastic load of an elastic member inserted in a clutch of an automatic clutch mechanism according to the related art.

FIG. 4 is a graph showing the relationship between the deformation and elastic load of an elastic member inserted in a clutch of an automatic clutch mechanism according to an embodiment of the present invention.

FIG. 5 is a cross-sectional view of an automatic clutch mechanism according to an embodiment of the present invention.

FIG. 6 is a cross-sectional view of a conical spring used in an automatic clutch mechanism according to an embodiment of the present invention, of which (a) is a view showing a natural state, (b) is a view showing a state in which the conical spring is deformed into a flat shape, and (c) is a view showing a reversed state.

FIG. 7 is a cross-sectional view showing an assembling state of a clutch of an automatic clutch mechanism according to an embodiment of the present invention.

FIG. 8 is a cross-sectional view showing an assembled state of a clutch of an automatic clutch mechanism according to an embodiment of the present invention.

FIG. 9 is a cross-sectional view showing a released state of a clutch of an automatic clutch mechanism according to an embodiment of the present invention.

FIG. 10 is a graph showing a relationship between deformation and elastic load according to an embodiment of the present invention.

FIGS. 11(a)-(d) are plan views of a modification of a conical spring (elastic member) according to an embodiment of the present invention.

### DETAILED DESCRIPTION OF THE INVENTION

The inventors wish to improve the operability of a pedal in an automatic clutch mechanism by making the reaction force exerted on the pedal as small as possible. Further, the inventors believe that transmitting the feel of gear shifting to the rider through the pedal will make the steering of a straddle-type vehicle more fun. Thus, the inventors examined improvements that could be made to automatic clutch mechanisms according to the related art. The inventors considered the mechanism of the reaction force exerted on the pedal, and the reason why the feel of gear shifting is not readily transmitted to the rider through the pedal, as follows.

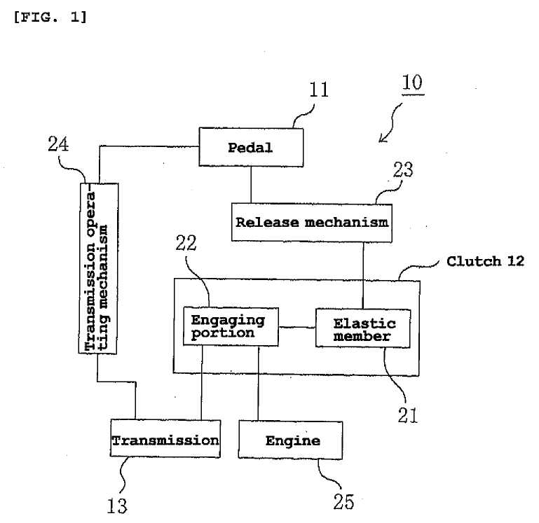

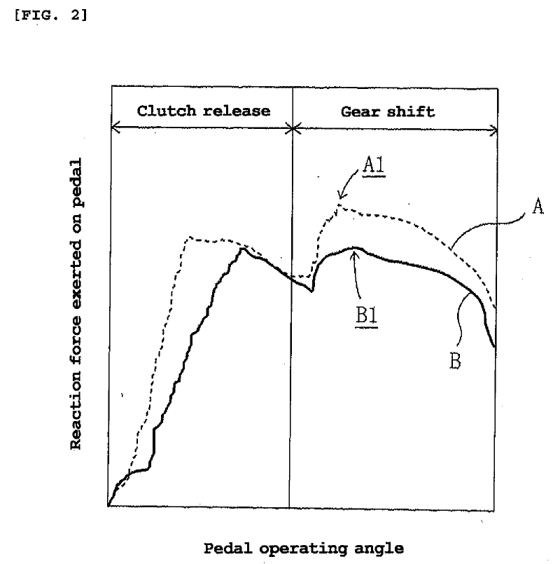

As shown in FIG. 1, an automatic clutch mechanism 10 includes a pedal 11, a clutch 12, and a transmission 13. Clutch 12 includes an engaging portion 22 for bringing transmission 13 and an engine 25 into engagement with each other by an elastic reaction force of an elastic member 21 inserted in clutch 12. Clutch 12 is operated by a release mechanism 23 that operates elastic member 21 in conjunction with a pedal 11. Transmission 13 is operated by a transmission operating mechanism 24 that operates in conjunction with pedal 11. Reaction forces exerted on pedal 11 from release mechanism 23 of clutch 12 and from transmission 13 for shifting gears, the elastic reaction force of elastic member 21 inserted in clutch 12, and the like are added in a superimposed fashion before being transmitted to a rider through pedal 11. Broken line A in FIG. 2 indicates the relationship between the operating angle (rotation angle of a pedal shaft rotatable in conjunction with a pedal operation) of pedal 11, and the reaction force exerted on pedal 11 in an automatic clutch mechanism according to the related art.

As indicated by broken line A, although the reaction force exerted on pedal 11 is small at the time when starting the operation of pedal 11, as the operating angle of pedal 11 is increased, the structural play becomes smaller, and the reaction forces applied from respective mechanisms gradually increase. In automatic clutch mechanism 10, release mechanism 23 of clutch 12 is operated first, and transmission 13 is operated after clutch 12 is disengaged. Accordingly, the timing at which transmission 13 is operated by transmission operating mechanism 24 is adjusted.

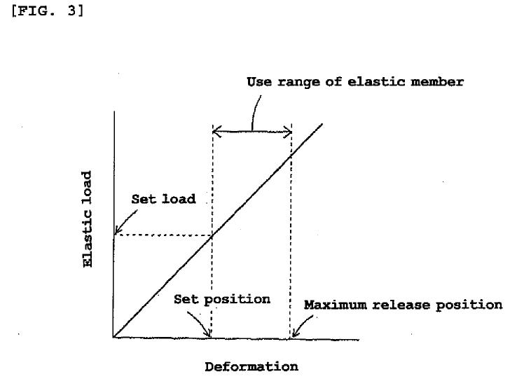

In the automatic clutch mechanism of the related art, in particular, elastic member 21 inserted in clutch 12 has such a characteristic that its elastic load increases generally in proportion to an increase in elastic deformation as shown in FIG. 3, and is disposed in clutch 12 under compression. When release mechanism 23 operates, elastic member 21 disposed under compression is further compressed, so the elastic reaction force from elastic member 21 gradually increases.

A particularly characteristic feature of the reaction force (pedal load) exerted on pedal 11 from transmission 13 is the change in reaction force at the time of gear shifting. That is, although not shown, at the time of gear shifting, a gear provided on the drive shaft is temporarily disengaged from a gear provided on the main shaft (gear disengagement). As indicated by broken line A in FIG. 2, the reaction force exerted on pedal 11 from transmission 13 at this time gradually increases until immediately before gear disengagement, and, as indicated at A1, momentarily decreases after the gear is disengaged. Such gear disengagement occurs in a state with clutch 12 released. At the time of gear disengagement, the reaction force exerted on pedal 11 is fairly large due to the elastic reaction force of elastic member 21 inserted in clutch 12, so the subtle feel of gear disengagement is not readily transmitted to the rider through pedal 11. That is, since the change in the reaction force exerted on pedal 11 from transmission 13 at the time of gear disengagement is relatively small in magnitude in comparison with the reaction force exerted on pedal 11, the feel of gear shifting (in particular, gear disengagement) is not readily transmitted to the rider through pedal 11.

The inventors considered the mechanism of the reaction force exerted on the pedal, and the reason why the feel of gear shifting is not readily transmitted to the rider through the pedal. The inventors have thus developed a completely novel automatic clutch mechanism that allows the feel of gear shifting to be readily transmitted to the rider through pedal 11.

An embodiment of the invention is now described with reference to the drawings.

JP Patent Applications Hei 8-15044 and 2004-19936 are incorporated herein for reference. The invention is not limited to the embodiment described below.

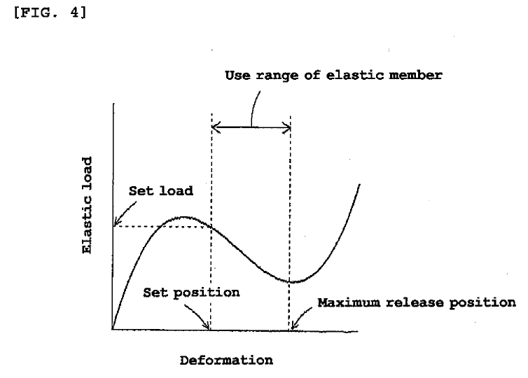

Automatic clutch mechanism 10 according to this embodiment shifts gears while disengaging clutch 12 in conjunction with one pedal operation. As shown in FIG. 1, automatic clutch mechanism 10 includes transmission 13 and clutch 12. Transmission 13 effects a gear shift in conjunction with a pedal operation. Clutch 12 includes elastic member 21, and engaging portion 22 for bringing transmission 13 and engine 25 into engagement with each other by an elastic reaction force of elastic member 21. In this embodiment, as shown in FIG. 4, elastic member 21 of clutch 12 has a gradient-decreasing range in which the gradient of a change in the elastic load of elastic member 21 with respect to deformation decreases as the deformation becomes larger. This gradient-decreasing range is included in the use range of the elastic member determined by the operation of clutch 12.

The above-mentioned gradient-decreasing range is included in the use range of elastic member 21. Therefore, as indicated by solid line B in FIG. 2, the reaction force (pedal load) exerted on pedal 11 at the time of gear shifting becomes generally small in comparison with the related art. This reduces the burden on the rider during pedal operation, thereby making it easier for the rider to operate the pedal. Since the reaction force exerted on pedal 11 becomes generally small as compared with the related art, at the time of gear shifting, the change in the reaction force exerted on pedal 11 (indicated at B1 in FIG. 2) is readily transmitted to the rider through pedal 11.

Automatic clutch mechanism 10 according to this embodiment is now described in more detail.

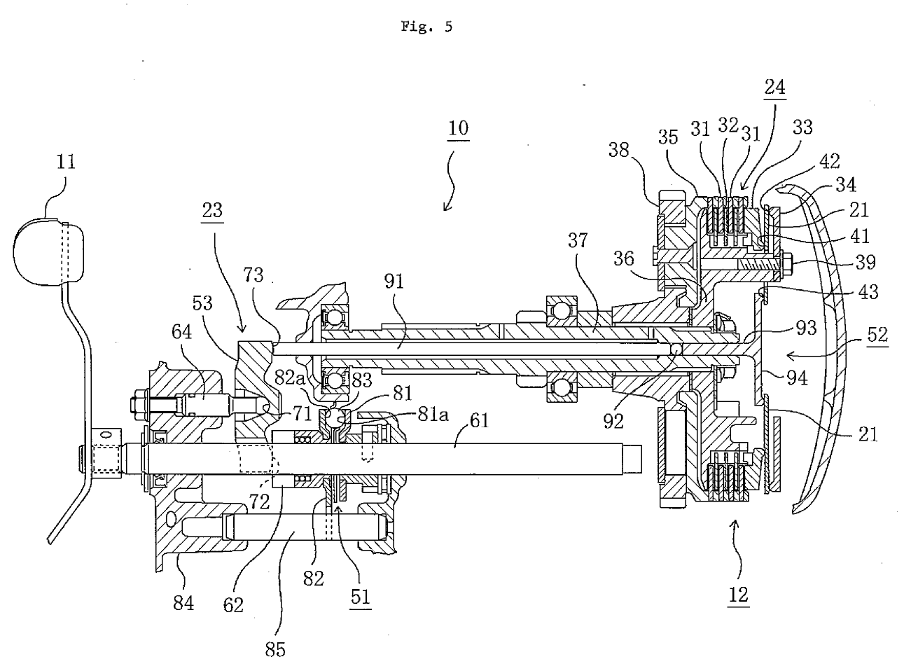

In this embodiment, as shown in FIG. 5, a generally conical spring is used as elastic member 21 inserted in clutch 12.

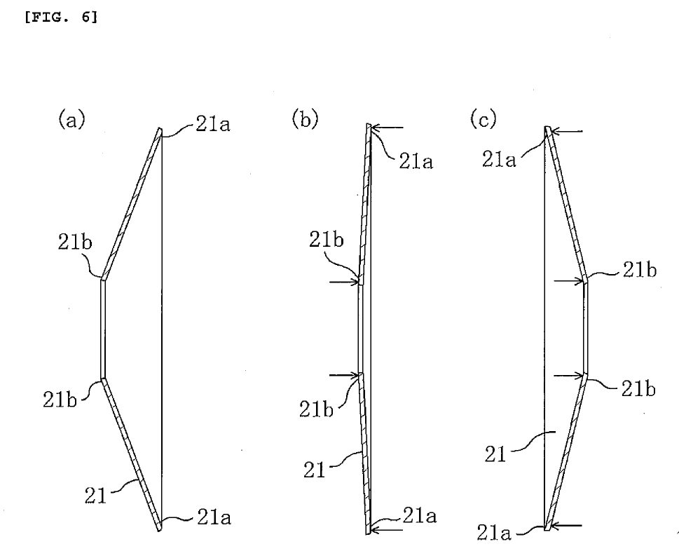

The longitudinal section of generally conical spring 21 is schematically shown in FIG. 6(a). As shown in FIG. 6(b), conical spring 21 becomes generally flat when elastically deformed by pressing a radially outer end 21a thereof from the inside and pressing a radially inner end 21b from the outside. When this pressing operation is further continued, as shown in FIG. 6(c), the inside and outside of the conical shape are reversed. In this embodiment, the amount of deformation of conical spring 21 refers to the amount of relative displacement by which radially inner end 21d is displaced from the position of radially inner end 21d in a natural state, with radially outer end 21a of conical spring 21 taken as a reference.

The elastic load with respect to deformation amount of conical spring 21 is shown in FIG. 4. In a range of small deformation amount, the elastic load gradually increases in accordance with deformation. Then, the elastic load reaches its peak at the time or shortly before and after when conical spring 21 reverses, and gradually decreases thereafter in accordance with the deformation.

In this case, the gradient of a change in elastic load with respect to deformation of elastic member 21 may be considered on the basis of the graph of FIG. 4 which shows the relationship between the deformation and elastic load of elastic member 21. That is, such a gradient may be evaluated on the basis of the gradient of the tangent of the graph. It should be noted that the gradient is not to be evaluated based on its absolute value but may be evaluated by taking positive and negative values into consideration. Conical spring 21 has a gradient-decreasing range in which the gradient of a change in elastic load with respect to deformation of conical spring 21 decreases as the deformation increases.

As shown in FIG. 4, the above-mentioned gradient-decreasing range is included in the use range of elastic member 21 determined by the operation of clutch 12. The gradient-decreasing range may be used over the entire use range of conical spring 21, or may be partially included in the use range of conical spring 21.

As shown in FIG. 5, the use range of the elastic member refers to a range in which conical spring 21 undergoes deformation by release mechanism 23, with the state of conical spring 21 disposed in clutch 12 taken as a reference. Conical spring 21 is mounted to clutch 12 under a state in which conical spring 21 becomes generally flat with a radially outer part 42 pressed from the right side in FIG. 5 and with a radially inner part 41 pressed from the left side in FIG. 5, or under a state shortly before and after conical spring 21 reverses. The deformation of conical spring 21 proceeds due to release mechanism 23 with conical spring 21 being in the reversed state. The elastic load thus gradually decreases in accordance with the operation of release mechanism 23.

Therefore, as indicated by solid line B in FIG. 2, the reaction force (pedal load) exerted on pedal 11 at the time of gear shifting becomes small as a whole in comparison with the related art. This reduces the burden on the rider during pedal operation, thereby making it easier for the rider to operate the pedal. Since the reaction force exerted on pedal 11 becomes small as a whole as compared with the related art, at the time of gear shifting, the change in the reaction force exerted on pedal 11 (indicated at B1 in FIG. 2) is readily transmitted to the rider through pedal 11.

Clutch 12 of automatic clutch mechanism 10, and the arrangement structure of conical spring 21, is now further described.

As shown in FIG. 5, clutch 12 is a multiplate clutch in which friction plates 31 and clutch plates 32 are overlaid together in a staggered fashion, with a pressure plate 33 overlaid on one side thereof. Generally conical spring 21 serving as an elastic member is mounted to clutch 12 by means of a mounting member 34, and is operated by release mechanism 23. In FIG. 5, reference numerals 35, 36, and 37 denote a clutch housing, a clutch boss, and a main shaft, respectively. A driven gear 38 is fitted onto clutch housing 35, and meshes with a drive gear of the engine. A gear of transmission 13 is fitted onto main shaft 37. Friction plates 31 and clutch plates 32 of clutch 12 are brought into engagement with each other by the elastic force of conical spring 21, thus transmitting torque from engine 25 (see FIG. 1) in the order of clutch housing 35, friction plates 31, clutch plates 32, clutch boss 36, and main shaft 37.

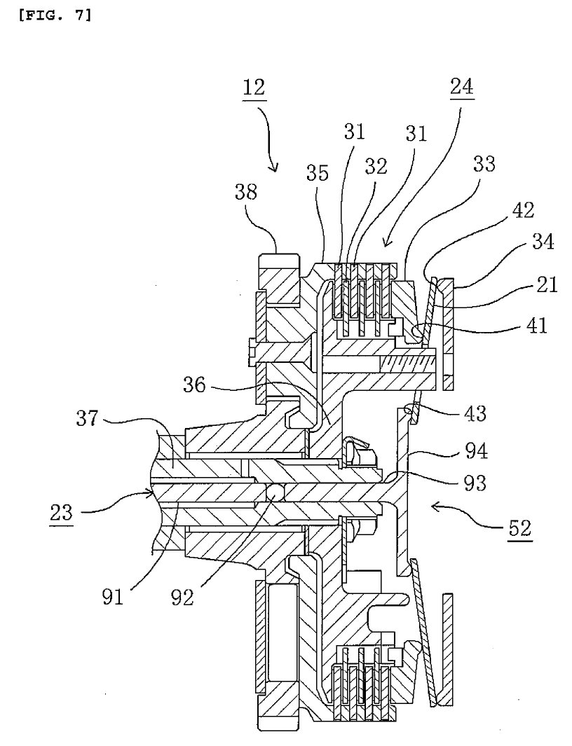

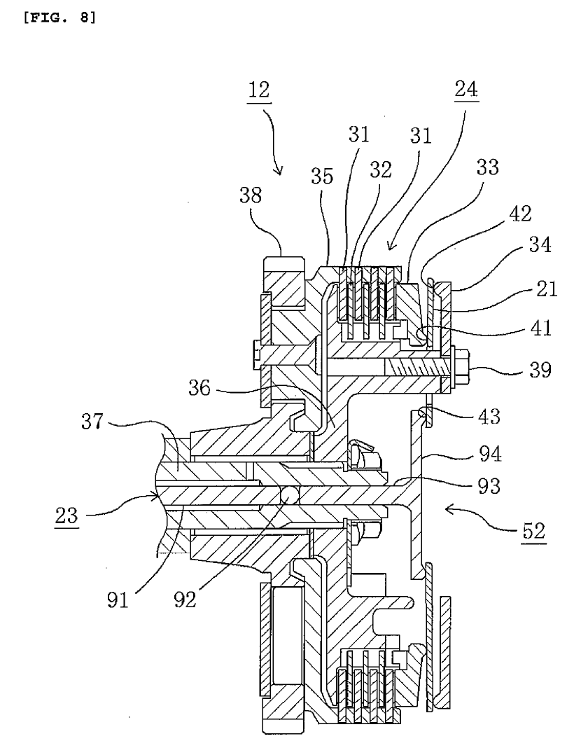

As shown in FIG. 7, a radially intermediate position 41 of the outer surface of conical spring 21 in the natural state is abutted on pressure plate 33 of clutch 12. As shown in FIG. 8, conical spring 21 is deformed by pressing mounting member 34 against a part 42 of conical spring 21 located on a radially outer side with respect to intermediate position 41, and moving radially outer part 42 to the pressure plate 33 side. A bolt 39 is passed through mounting member 34 and fitted to clutch boss 36, thereby moving radially outer part 42 of conical spring 21 to the pressure plate 33 side to thereby deform conical spring 21. By mounting conical spring 21 to clutch 12 in this way, pressure plate 33 is pressed by the elastic reaction force of conical spring 21, thereby bringing friction plates 31 and clutch plates 32 into press contact with each other. Subsequently, in this state, a part 43 of conical spring 21 located on a radially inner side with respect to intermediate position 41 is abutted against release mechanism 23.

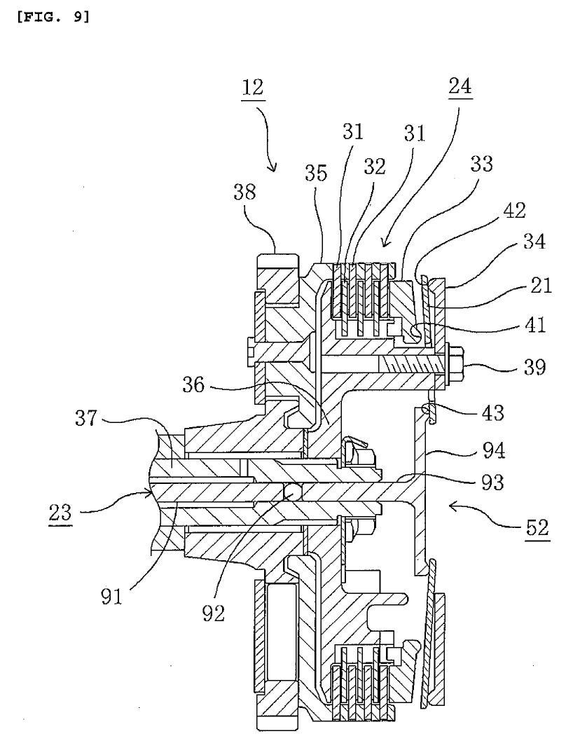

When disengaging clutch 12, as shown in FIG. 9, release mechanism 23 that operates in conjunction with conical spring 21 projects to the right side in the drawing, thus causing radially inner part 43 of conical spring 21 to move to the side opposite to pressure plate 33. The force of conical spring 21 pressing pressure plate 33 is thus removed, so the press contact between friction plates 31 and clutch plates 32 is released, thereby disengaging clutch 12.

In this embodiment, the natural state of conical spring 21 refers to a state in which no external force is being exerted on conical spring 21. Further, the “use range of the elastic member” refers to the deformation range of the conical spring from the state in which conical spring 21 is incorporated into clutch 12 as shown in FIG. 8, to the state in which the conical spring has been deformed to the maximum position due to the operation of release mechanism 23 as shown in FIG. 9. As shown in FIG. 4, the above-mentioned gradient-decreasing range is included in the use range of elastic member 21 determined by the operation of clutch 12.

As shown in FIG. 8, the distance from radially outer part 42 of conical spring 21 engaging with mounting member 34 to radially inner part 43 engaging with release mechanism 23 is set larger than the distance from radially outer part 42 of conical spring 21 engaging with mounting member 34 to intermediate position 41 at which conical spring 21 is in abutment with pressure plate 33. That is, the arrangement structure of conical spring 21 utilizes the principle of leverage with radially outer part 42 engaging with mounting member 34 serving as a fulcrum, radially outer part 43 engaged with release mechanism 23 serving as a force point, and point 41 in abutment with pressure plate 33 serving as an action point.

Since the principle of leverage is used for the arrangement structure of conical spring 21, release mechanism 23 can be operated with less force in comparison with the elastic reaction force of conical spring 21 exerted on pressure plate 33.

Although conical spring 21 undergoes further deformation as release mechanism 23 operates against conical spring 21, the elastic reaction force from conical spring 21 does not become larger in comparison with the related art. Consequently, when pedal 11 is operated and clutch 12 operates due to release mechanism 23, the reaction force exerted on pedal 11 at this time due to the elastic reaction force of elastic member 21 inserted in clutch 12 becomes generally small in comparison with the related art.

Accordingly, when automatic clutch mechanism 10 is adopted for a straddle-type vehicle, the reaction force exerted on pedal 11 when gears are shifted by operating pedal 11 to engage/disengage clutch 12 becomes generally small in comparison with the related art. Therefore, at the time of gear shifting, the change in the reaction force exerted on pedal 11 is readily transmitted to the rider through pedal 11. Since the reaction force exerted on pedal 11 becomes generally small in comparison with the related art, the burden placed on the rider during pedal operation can be reduced as well.

The distance from radially outer part 42 engaging with mounting member 34 to radially inner part 43 engaging with release mechanism 23 is set larger than the distance from radially outer part 42 engaging with mounting member 34 to intermediate position 41 in abutment with pressure plate 33. That is, conical spring 21 utilizes the principle of leverage with its radially outer part engaged with mounting member 34 serving as a fulcrum, its radially outer part engaged with release mechanism 23 serving as a force point, and point 41 in abutment with pressure plate 33 serving as an action point. This allows release mechanism 23 to disengage clutch 12 by pressing conical spring 21 with less force.

As described above, conical spring 21 is used as the elastic member, and the principle of leverage is utilized for the arrangement structure of conical spring 21, thereby making the reaction force exerted on pedal 11 small.

In this embodiment, the release mechanism is also contrived as follows.

Since the above-described structure utilizes the principle of leverage for the arrangement structure of conical spring 21, the amount of movement of the point (action point) at which conical spring 21 is in abutment with pressure plate 33 is small relative to the amount of movement of radially inner part 43 (force point) of conical spring 21 engaging with release mechanism 23. To ensure reliable disengagement of clutch 12, the point (action point) at which conical spring 21 is in abutment with pressure plate 33 must be moved by a predetermined distance. Achieving this by increasing the operating angle of pedal 11 is not desirable since the operating angle of pedal 11 has been adjusted to about 20 degrees (in this embodiment, 18 degrees) by taking the operability for the rider into consideration.

In view of this, as shown in FIG. 5, release mechanism 23 includes a conversion mechanism 51, a pushing member 52, and a lever member 53. Conversion mechanism 51 includes an output member 62 that outputs linear motion on the basis of the rotation of a pedal shaft 61 that rotates in conjunction with pedal 11. Pushing member 52 is a member that abuts against radially inner part 43 of conical spring 21 and moves linearly in conjunction with the linear motion of output member 62 to push conical spring 21 away from the pressure plate. Lever member 53 has a fulcrum 71 swingably supported on a fixing member 64, a force point 72 at which linear motion is inputted from output member 62, and an action point 73 in abutment with pushing member 52 and at which linear motion is outputted to pushing member 52.

By utilizing the principle of leverage for release mechanism 23, pushing member 52 that abuts against conical spring 21 can be moved by a predetermined distance in accordance with operation of pedal 11, without changing the operating angle of pedal 11.

The distance from the fulcrum to the action point in lever member 53 is set to be larger than the distance from the fulcrum to the force point. The movable distance of pushing member 52 abutted against conical spring 21 can be thus increased without changing the operating angle of pedal 11. This ensures reliable clutch disengagement also in the case where the principle of leverage is utilized for the arrangement structure of conical spring 21 as described above.

The structure of release mechanism 23 is now described in more detail.

As shown in FIG. 5, conversion mechanism 51 includes an input member 81, a conversion member 82, and a ball 83 in addition to output member 62. Input member 81 is a plate-like member fixed to pedal shaft 61, and conversion member 82 is a plate-like member movable along pedal shaft 61 without rotation. The rotation of conversion member 82 is restricted by being engaged with another shaft 85 that is arranged in a housing 84, to which pedal shaft 61 is mounted, so as to extend in parallel to pedal shaft 61. Input member 81 and conversion member 82 are arranged so as to be opposed to pedal shaft 61, and have formed in their respective opposing surfaces depressions 81a, 82a in which ball 83 is fitted. Ball 83 is held between depressions 81a, 82a of input member 81 and conversion member 82. Output member 62 is fitted onto pedal shaft 61, and is attached to conversion member 82.

Pushing member 52 includes a first rod 91, a ball 92, and a second rod 93 that are inserted in hollow main shaft 37 of transmission 13. First rod 91 projects to lever member 53 side from main shaft 37. Ball 92 is held between first rod 91 and second rod 93. Ball 92 is a member for transmitting axial motion between first rod 91 and second rod 93 without transmitting rotation. The distal end portion of second rod 93 which projects from main shaft 37 radially diverges to prevent detachment from main shaft 37. An arm portion 94 extends radially outwards from the distal end of second rod 93. Arm portion 94 is in abutment with the inner surface (surface abutting against pressure plate 33) of radially inner part 43 of conical spring 21 in the natural state.

Lever member 53 is a member that is swingably supported on fixing member 64 fixedly disposed in housing 84 in a fixed manner. One side of lever member 53 abuts against output member 62 of conversion mechanism 51, and the other side thereof abuts against an end of first rod 91 of pushing member 52. The point swingably supported on fixing member 64 serves as fulcrum 71, the point in abutment with output member 62 serves as force point 72, and the point in abutment with pushing member 52 serves as action point 73.

When the rider operates pedal 11, pedal shaft 61 and input member 81 rotate, and the positions of depressions 81a, 82a of input member 81 and conversion member 82 are circumferentially shifted. When the positions of depressions 81a, 82a of input member 81 and conversion member 82 are shifted, ball 83 held between depressions 81a, 82a of input member 81 and conversion member 82 move while rolling so as to dislodge from depressions 81a, 82a. At this time, since input member 81 is fixed to pedal shaft 61, and the rotation of conversion member 82 is restricted by shaft 85, as ball 83 rolls so as to dislodge from depressions 81a, 82a, conversion member 82 moves to the left side in FIG. 5 along pedal shaft 61. Output member 62 is attached to conversion member 82 and thus moves to the left side in FIG. 5 together with conversion member 82.

As output member 62 moves to the left side in FIG. 5, lever member 53 in abutment with output member 62 swings about fulcrum 71, causing pushing member 52 abutting on the side opposite to lever member 53 to be pushed to the clutch 12 side (the right side in FIG. 5). As pushing member 52 is pushed, the radially inner part of conical spring 21 abutted against pushing member 52 is pushed so as to move away from pressure plate 33, and the pressing force exerted on pressure plate 33 from conical spring 21 is relieved, so clutch 12 is disengaged.

As described above, lever member 53 is interposed in release mechanism 23 to transmit the motion of output member 62 to pushing member 52, thereby moving pushing member 52 by a required distance. This also makes it possible, for example, to largely move pushing member 52 relative to the movement of output member 62. As described above, the principle of leverage is utilized when disposing conical spring 21, and is also utilized for release mechanism 23, thereby ensuring more reliable operation of clutch 12.

In this embodiment, transmission operating mechanism 24 (see FIG. 1) is connected to pedal shaft 61 shown in FIG. 5. Transmission operating mechanism 24 includes a ratchet mechanism or the like, and causes transmission 13 to operate at the timing when clutch 12 is disengaged by release mechanism 23, in conjunction with rotation of pedal shaft 61. As described above, the reaction force exerted on pedal 11 due to the elastic reaction force of conical spring 21 can be kept small. In particular, at the timing when clutch 12 is disengaged by release mechanism 23 and transmission 13 is operated by transmission operating mechanism 24, the reaction force exerted on pedal 11 can be kept small. The feel of gear shifting is thus readily transmitted to the rider through pedal 11.

While an automatic clutch mechanism according to an embodiment of the present invention has been described, the automatic clutch mechanism according to the invention is not limited to the described embodiment.

For example, according to the foregoing description, by taking into consideration the gradient of a change in elastic load with respect to deformation of elastic member 21, elastic member 21 of clutch 12 has the gradient-decreasing range in which the gradient decreases as the deformation of the elastic member 21 increases. Further, the gradient-decreasing range is included in the use range of elastic member 21 determined by operation of clutch 12.

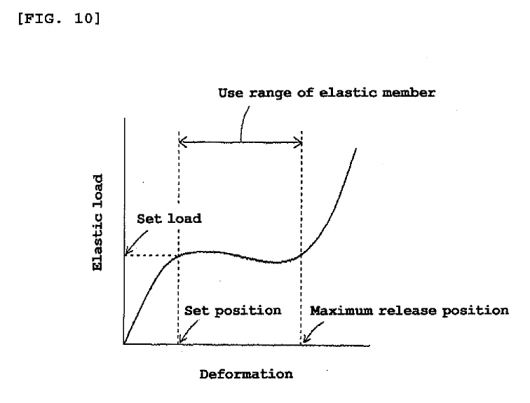

The elastic characteristic of elastic member 21 is not limited to the one shown in FIG. 4. Any elastic characteristic suffices as long as it includes a gradient-decreasing range, such as the one shown in FIG. 10, for example. In this case, the entire use range of elastic member 21 may be constituted by a gradient-decreasing range. This makes it possible to more effectively attain the effect of keeping the reaction force exerted on the pedal small.

Elastic member 21 of clutch 12 can be also evaluated on the basis of the elastic load with respect to deformation of elastic member 21. That is, as shown in FIG. 4, elastic member 21 has an elastic-load-decreasing range in which the elastic load with respect to deformation of elastic member 21 decreases as the deformation increases. The elastic-load-decreasing range is included in the use range of elastic member 21 determined by the operation of clutch 12.

Since the elastic-load-decreasing range is included in the use range of the elastic member, as shown in FIG. 2, the reaction force exerted on pedal 11 at the time of gear shifting becomes generally small in comparison with the related art. Therefore, at the time of gear shifting, the change in the reaction force exerted on pedal 11 is readily transmitted to the rider through pedal 11. Further, since the reaction force exerted on pedal 11 becomes generally small in comparison with the related art, the burden placed on the rider during pedal operation can be reduced as well. The above-mentioned configuration of the elastic member is also conceivable for automatic clutch mechanism 10 according to the above-described embodiment.

In the above-described embodiment, as shown in FIG. 4, the elastic-load-decreasing range is included in the entire use range of elastic member 21 determined by the operation of clutch 12. Therefore, the above-mentioned effect, namely that when clutch 12 is operated by release mechanism 23, the reaction force exerted on pedal 11 due to the elastic reaction force of elastic member 21 inserted in clutch 12 becomes generally small in comparison with the related art, becomes significant. At the time of gear shifting, the change in the reaction force exerted on pedal 11 is transmitted to the rider through pedal 11 in a more readily noticeable fashion. It should be noted, however, that the elastic-load-decreasing range is not always necessarily used over the entire use range of the conical spring.

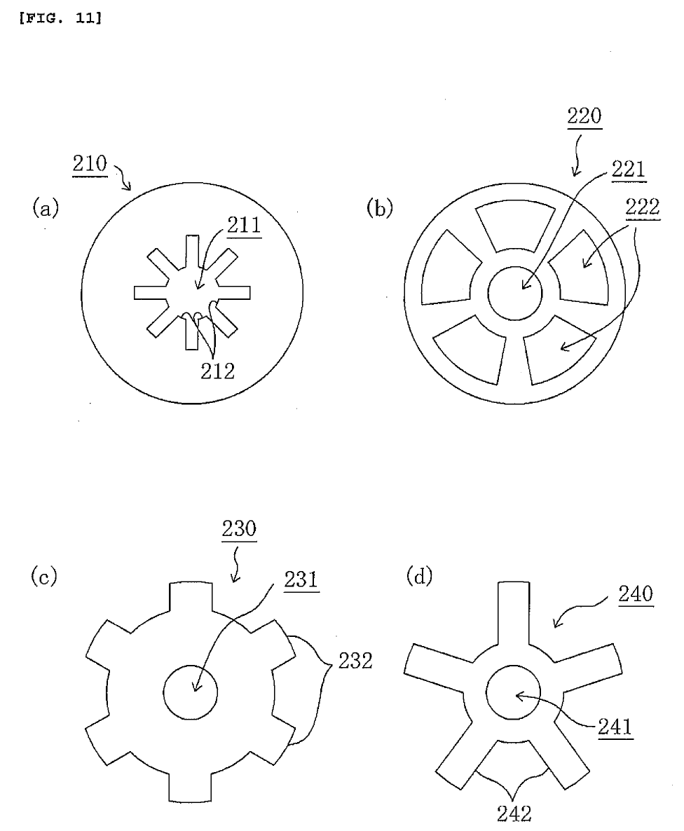

While in the above-described embodiment a generally conical spring is used as the elastic member, the configuration of the conical spring can be modified in various ways in accordance with the structure of the clutch. For example, as shown in FIG. 11(a), the conical spring may be a generally conical spring 210 in which a hole 211 formed at the central portion includes strip portions 212 that protrude radially inward. Further, as shown in FIG. 11(b), the conical spring may be a generally conical spring 220 in which a hole 221 is formed at the central portion, with holes 222 formed at plural locations in the circumferential direction. Further, as shown in FIG. 11(c), the conical spring may be a generally conical spring 230 that has a hole 231 at the central portion and includes strip portion 232 that protrude radially outward. Further, an elastic member 240 shown in FIG. 11(d) is a generally conical spring formed by modifying the conical spring shown in FIG. 11(c) by making a central portion 241 smaller and increasing the length of the strip portions 242 that protrude radially outward. The conical spring may be also configured like elastic member 240. As described above, any elastic member may be used as long as it exhibits a required elastic characteristic that includes the above-described gradient-decreasing range or elastic-load-decreasing range. A conical spring or other such leaf spring may be used.

Further, while a conical spring has been described as an example of elastic member, the elastic member is not limited to a conical spring or leaf spring. Any elastic member (elastic body) may be inserted in the clutch of the automatic clutch mechanism according to the present invention as long as it includes the gradient-decreasing range or elastic-load-decreasing range as described above. Examples include an air spring whose elastic characteristic can be changed in accordance with the amount of air. Further, the elastic member used may be a coil spring as long as it is provided with the gradient-decreasing range or elastic-load-decreasing range as described above, such as through combination of coil springs of different elastic characteristics. The structure of the clutch may be modified as appropriate in accordance with the configuration of the elastic member. The structure of the clutch or release mechanism may also be altered as appropriate. In the case where an air spring or coil spring is adopted for the elastic member, the following structure may be adopted. That is, the automatic clutch mechanism includes a release mechanism that operates in conjunction with a pedal operation, the elastic member engages with each of the engaging portion and the release mechanism, and as the release mechanism operates, the part of the elastic member engaging with the release mechanism is displaced relative to the part engaging with the engaging portion and an elastic load is exerted.

Automatic clutch mechanism 10 according to the embodiment includes transmission 13 for shifting gears in conjunction with a pedal operation, clutch 12 including elastic member 21 and engaging portion 22 for bring transmission 13 and the engine into engagement with each other in response to the elastic reaction force of elastic member 21, mounting member 34 for mounting elastic member 21 in position by causing elastic member 21 to undergo elastic deformation while being abutted against engaging portion 22 of clutch 12, and release mechanism 23 for releasing clutch 12 by deforming elastic member 21 while engaging with elastic member 21. In elastic member 21, the distance from the part abutted against mounting member 34 to the part engaged with release mechanism 23 is set larger than the distance from the part abutted against mounting member 34 to the part abutting against engaging portion 22 of clutch 12.

Due to the arrangement structure of elastic member 21 as described above, the reaction force exerted on the pedal due to the elastic reaction force of elastic member 21 becomes generally small in comparison with the related art, thereby reducing the burden on the rider during pedal operation. Further, the reaction force exerted on pedal 11 due to the elastic reaction force of elastic member 21 becomes small, and at the time of gear shifting, the change in the reaction force exerted on the pedal is readily transmitted to the rider through the pedal. Therefore, the above-described automatic clutch mechanism is suitable for use as the automatic clutch mechanism for a straddle-type vehicle. A substantially conical spring can be used as elastic member 21.

As described above, the present invention provides a straddle-type vehicle with an automatic clutch mechanism that more readily transmits the feel of gear shifting to the rider via the pedal as compared with the related art.

The particular embodiments of the invention described in this document should be considered illustrative, rather than restrictive. Modification to the described embodiments may be made without departing from the spirit of the invention as defined by the following claims.

1. An automatic clutch mechanism for shifting gears while disengaging a clutch in conjunction with one pedal operation, comprising:
a transmission for shifting gears in conjunction with pedal operation; and
a clutch including an elastic member, and an engaging portion for bringing the transmission and an engine into engagement with each other by an elastic reaction force of the elastic member,
wherein the elastic member of the clutch has a gradient-decreasing range in which a gradient of a change in elastic load with respect to deformation of the elastic member decreases as the deformation increases; and
the gradient-decreasing range is included in a use range of the elastic member determined by operation of the clutch.

2. The automatic clutch mechanism according to claim 1, wherein the elastic member is configured so that the entirety of the use range is the gradient-decreasing range.

3. An automatic clutch mechanism for shifting gears while disengaging a clutch in conjunction with one pedal operation, comprising:
a transmission for shifting gears in conjunction with pedal operation; and
a clutch including an elastic member, and an engaging portion for bringing the transmission and an engine into engagement with each other by an elastic reaction force of the elastic member,
wherein the elastic member of the clutch has an elastic-load-decreasing range in which an elastic load with respect to deformation of the elastic member decreases as the deformation increases; and
the elastic-load-decreasing range is included in a use range of the elastic member determined by operation of the clutch.

4. The automatic clutch mechanism according to claim 3, wherein the elastic member is configured so that the entirety of the use range is the elastic-load-decreasing range.

5. The automatic clutch mechanism according to claim 1,
wherein the clutch includes a release mechanism for operation in conjunction with pedal operation; and
the elastic member engages with each of the engaging portion and the release mechanism, and due to operation of the release mechanism, a part of the elastic member engaging with the engaging portion is displaced relative to a part of the elastic member engaging with the release mechanism, and the elastic member exerts the elastic load.

6. The automatic clutch mechanism according to claim 1,
wherein the clutch is a multiplate clutch in which a friction plate and a clutch plate are overlaid together in a staggered fashion and a pressure plate is overlaid on one side thereof;
the elastic member is a generally disc-shaped leaf spring;
the automatic clutch mechanism further comprises:
a mounting member that causes a radially intermediate position of an outer surface of the leaf spring in a natural state to abut against the pressure plate of the clutch, and engages with a radially outer part of the leaf spring with respect to the intermediate position of the leaf spring, the mounting member being configured to mount the leaf spring to the clutch by moving the radially outer part toward the pressure plate; and
a release mechanism that engages with a radially inner part of the leaf spring with respect to the intermediate position of the leaf spring, and operates in conjunction with the pedal operation to move the radially inner part to a side opposite to the pressure plate.

7. The automatic clutch mechanism according to claim 6, wherein the leaf spring is configured so that a distance from the radially outer part engaging with the mounting member to the radially inner part engaging with the release mechanism is larger than a distance from the radially outer part engaging with the mounting member to the intermediate position abutting against the pressure plate.

8. The automatic clutch mechanism according to claim 6, wherein the leaf spring is a generally conical spring.

9. The automatic clutch mechanism according to claim 6, wherein the release mechanism includes:
a pedal shaft rotatable in conjunction with a pedal;
a conversion mechanism including an output member that outputs linear motion on the basis of rotation of the pedal shaft;
a pushing member that abuts against the radially inner part of the conical spring, and moves linearly in conjunction with linear motion of the output member to push the conical spring away from the pressure plate; and
a lever member having a fulcrum swingably supported on a fixing member, a force point at which linear motion is inputted from the output member, and an action point at which linear motion is outputted to the pushing member.

10. The automatic clutch mechanism according to claim 9, wherein the lever member is configured so that a distance from the fulcrum to the action point is larger than a distance from the fulcrum to the force point.

11. An automatic clutch mechanism for a straddle-type vehicle for shifting gears while disengaging a clutch in conjunction with one pedal operation, comprising:
a transmission for shifting gears in conjunction with pedal operation;
a clutch including an elastic member, and an engaging portion for bringing the transmission and an engine into engagement with each other by an elastic reaction force of the elastic member;
a mounting member for mounting the elastic member in position by causing the elastic member to elastically deform while being abutted against the engaging portion of the clutch; and
a release mechanism for releasing the clutch by deforming the elastic member while engaging with the elastic member,
wherein the elastic member is configured so that a distance from a part of the elastic member abutted against the mounting member to a part of the elastic member engaging with the release mechanism is larger than the part of the elastic member abutted against the mounting member to a part of the elastic member abutted against the engaging portion of the clutch.

12. The automatic clutch mechanism for a straddle-type vehicle according to claim 11, wherein the elastic member is a leaf spring.

13. The automatic clutch mechanism for a straddle-type vehicle according to claim 12, wherein the leaf spring is a generally conical spring.

14. The automatic clutch mechanism for a straddle-type vehicle according to claim 11,
wherein the elastic member is a generally conical spring; and
the release mechanism includes:
a pedal shaft rotatable in conjunction with a pedal;
a conversion mechanism including an output member that outputs linear motion on the basis of rotation of the pedal shaft;
a pushing member that abuts against radially inner part of the leaf spring, and moves linearly in conjunction with linear motion of the output member to push the leaf spring away from a pressure plate; and
a lever member having a fulcrum swingably supported on a fixing member, a force point at which linear motion is inputted from the output member, and an action point at which linear motion is outputted to the pushing member.

15. The automatic clutch mechanism for a straddle-type vehicle according to claim 14, wherein the lever member is configured so that a distance from the fulcrum to the action point is larger than a distance from the fulcrum to the force point.

16. A straddle-type vehicle comprising the automatic clutch mechanism of claim 1.
